(19) United States
(12) Patent Application Publication
(10) Pub. No.: US 2004/0140062 A1
(43) Pub. Date: Jul. 22, 2004

(54) Quantitative shutter construction system and installation method

(76) Inventor: Han-Sen Lee, Hsien (TW)

Correspondence Address: Curt Harrington, Suite 250, 6300 State University Drive, Long Beach, CA, 90815, US

(21) Appl. No.: 10/346,741

(22) Filed: Jan. 17, 2003

(51) Int. Cl. E06B 3/48

(52) U.S. Cl. 160/117

(57) ABSTRACT

A quantitative shutter construction system and installation method for shutters enables the the provision of a window opening of given dimension and for which a series of pre-cut parts are selected from a set of parts set having a prime quantum magnitude distance magnitude with regard to their vertical and horizontal dimensions with a selection based upon prime quantum magnitude distance as a difference between the next longer and next shorter member. A frame system and a window shutter system which fits within the frame system is also provided in discrete quanta of linear magnitude to provide a result of no more than a quanta of magnitude smaller than the window opening. Shimming is used to center and fit the frame into the window opening, with attachment had by preferably direct threaded attachment into either the face or the inside of a window opening. Where the window opening is uneven, and has edges which are non-linear, the clearance provides accommodation for deviations into the opening for which the system compensates.

### FIELD OF THE INVENTION

The present invention relates to a quantitized structure for close mounting and applying shutter sets, and more specifically to provide a seller and constructor of shutter sets a methodology for selective construction in a manner to eliminate the use of custom cutting and interfit which helps the constructor save time, and to produce a shutter set of a more highly customized appearance to help the installer both save time and reduce the possibility of misfit.

### BACKGROUND OF THE INVENTION

Prior art structures for shutters, both window and door, have involved the use of a captured frame set which involves the mounting of the shutter doors on a fixed support and the fitting of the fixed support into a window or door opening. Purely custom installation may involve the raw window opening with all its deviations based upon being out of square, tilted, or other problems, with the dimensional anomalies accounted for by close cutting.

Most framed window shutter sets, even highly custom sets, are based upon forming a frame which will fit a given size window, followed by the building of the shutters within the given size of frame specified. Where the frame is of custom or exacting size, the components of the shutter set are cut to conform with the custom or exacting size. With most shutter sets, the exacting size requirement can cause the imposition of cutting upon any number of components, but predominantly of components of given larger size.

In many cases, custom shutter sets have a relatively small louver size for a given shutter door size simply to provide a sufficient amount of additional material for trimming. Trimming, or making small precise cuts, can result in significant scrap where even a little too much material is cut. This is especially true where the major components are already made up and where the person constructing the shutter set tries to maintain a centered panel appearance. Over cutting in any direction can result in scrapping the complete panel.

Finishing time and effort is another improvement area. Installers are not typically equipped to provide a complete finish on a shutter set. Where an installer must perform custom cuts, paint has to be re-applied on the cut portions. Painting has to be done with a brush, etc. and results in an uneven and shabby appearance. Painting on a completely pre-assembled shutter set can be performed in a spray booth in a manufacturing facility, but again this requires an exacting measurement and extensive pre-cutting at a location far from the point of installation. It is much better for all of the structures which are included into a finished shutter set to have been painted completely after cutting operations.

### SUMMARY OF THE INVENTIONS

A quantitative shutter construction system and installation method for shutters involves the provision of a window opening of given dimension and for which a series of pre-cut parts are selected from a set of parts set having a prime quantum dimension magnitude differential with regard to their vertical and horizontal dimensions with a selection based upon primary quantum dimension magnitude differential distance as a difference between the next longer and next shorter member. Quantum indicates a magnitude significantly greater than zero which is used as a size gradation magnitude between a given size and the next higher size and the next lower size. Thus by using quantum, or discrete differences as a multiple on which to select a series of sizes, billions of other possibilities are eliminated.

A frame system and a window shutter system which fits within the frame system is also provided in discrete quanta of linear magnitude, which translates into a discrete quanta of vertical and horizontal magnitude, to provide a gross result of no more than a quanta of magnitude smaller than the window opening. Prime is a primary quantity and an independent vertical quantity may be used which is different from an independent horizontal quantity.

It is understood that any prime quantum dimension magnitude differential can include quantum magnitude differences between next longer or next shorter members and can can have a base amount which includes an absolute magnitude which is not an integer multiple of the prime quantum magnitude. For example, a system having a quarter inch difference between sizes could have a base amount of 1.235923 inches with different sizes being equivalent to the base amount plus some integer number of the quantum difference. It is preferable for the system to have a whole width and height magnitude which may be a whole quantum integer multiple, but a system which incorporates a base magnitude plus integer quantum magnitude multiple is contemplated to be within the teaching of the system as stated herein.

Two components may have individual magnitudes which have common quantum multiples of each other in the whole, or which have common quantum multiples after the subtraction of the base amount. A system in which differences in dimension of various components end up being some multiple of a quarter of an inch, for example yields a common quantum multiple of a quarter of an inch. A common quantum multiple may be different in measuring vertical dimensions than in measuring horizontal dimensions.

Shimming can be used to center and fit the frame into the window opening, with attachment had by direct threaded attachment into either the face or the inside of a window opening. Where the window opening is uneven, and has edges which are non-linear, the clearance provides accommodation for deviations into the opening which can be compensated for by shimming, and a frame lip overhang onto the outside surface is provided for deviations away from the opening by providing coverage.

### BRIEF DESCRIPTION OF THE DRAWINGS

The invention, its configuration, construction, and operation will be best further described in the following detailed description, taken in conjunction with the accompanying drawings in which:

FIG. 1 is a perspective of the most basic unit of the shutter system for purposes of initial illustration;

FIG. 2 is an exploded view of the shutter system of FIG. 1, for illustration of the component parts thereof;

FIG. 3 is an end view of a first vertical panel seen in FIGS. 1 and 2;

FIG. 4 is an end view of a second vertical panel seen in FIGS. 1 and 2 in which an overlap notch is provided;

FIG. 5 is an end view of a lower connector panel 43 which illustrates its notch and pre drilled connection bores;

FIG. 6 is an end view of a frame member showing its dimensions;

FIG. 7 is an end view of a decorative molding seen in FIGS. 1 and 2;

FIG. 8 is a plan view of a second embodiment of a decorative molding which can be used in place of the decorative molding seen in FIG. 7;

FIG. 9 is an end view of the decorative molding of FIG. 8; and

FIG. 10 is a perspective view of a hinged four shutter set.

### DETAILED DESCRIPTION OF THE PREFERRED EMBODIMENTS

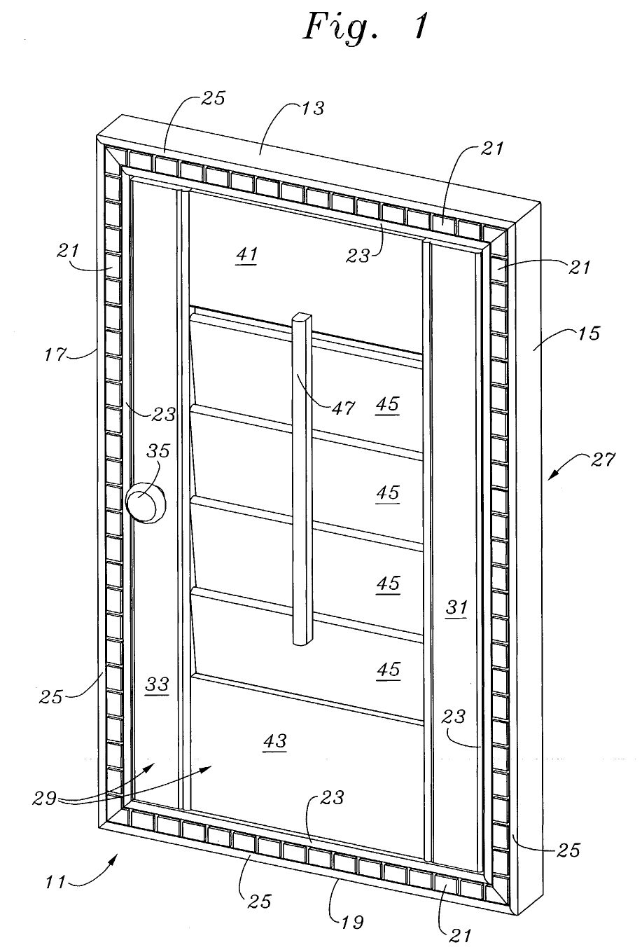

A description of a simplified version the inventive quantitative shutter system is shown in FIG. 1 as a quantitative shutter construction system 11. FIG. 1 is an overly simplified view of a generally minimum number of the assembled components of the quantitative shutter construction system 11, seen as a single door shutter configuration. System 11 in an actual realization would be more likely to have at least two and probably not more than five panel opening portions with panel portions hingeably linked to each other and hingeably dependend from a frame surface. The system 11 shown has an upper frame member 13, right side frame member 15, left side frame member 17 and a lower frame member 19.

The frame members 13, 15, 17, and 19 support lengths of decorative molding 21. Both the frame members 13, 15, 17, and 19 and decorative molding 21 are shown as being cut at a 45° angle but need not be. Appropriate end modification to accommodate rear fit could accompany any joinder of the members seen, including a rounded effect or a multi angled effect such as an octagon.

The decorative molding 21 fits within a slot(to be shown more fully) in the frame members 13, 15, 17, and 19 and thus frame members 13, 15, 17, and 19 also have an inside edge surface 23 and an outside edge surface 25. The decorative molding 21 which fit into a slot between the inside and outside edge surfaces 23 and 25 acts to hide bores which accommodate attachment screws which secure the assembled frame members 13, 15, 17, and 19 directly into the periphery of a window opening. As an alternative to the frame members 13, 15, 17, and 19 to be screwed or bolted directly through the window opening face, they can be secured laterally with inside attachment bores. Regardless, the frame members 13, 15, 17, and 19 enable a sufficient number of screws or bolts to create significant holding forces on the quantitative shutter construction system 11.

The members thus far described as frame members 13, 15, 17, and 19, decorative molding 21 and the inside edge surface 23 and outside edge surface 25 may be collectively referred to as the frame system 27. Within the frame system 27 is shown at least one shutter door system 29. Although the realized construction will involve multiple numbers of shutter door systems 29 each will generally be expected to be identical to the others or at least having enough shared identity to promote symmetry.

The shutter door system 29 includes a first vertical panel 31, typically a hinged panel, and an oppositely located second vertical panel 33. Second vertical panel 33 is shown with a pull knob 35.

The main connection of structural integrity between the first and second vertical panels 31 and 33 is an upper connector panel 41 along with a lower connector panel 43. Between the upper and lower connector panels 31 and 33 a series of louvers 45 are pivotally supported by and between the first and second vertical panels 31 and 33, and operably joined by connection to an actuation bar 47.

The actuation bar 47 can be connected to the louvers 45 in any number of ways and actuation bar 47 is shown as one way to keep a number of louvers 45 together in a group for quick mounting during the construction of a shutter door system 29. Along with the different length and width components which differ by a quantum amount, a series of sets of different size louvers 45 and actuation bar 47 should ideally be available to enable users to select the overall look of any resulting system 11. Differences may involve a lesser number of shutter door systems 29 with larger louver openings or a larger number of shutter door system 29, or selecting two difference size sets of louvers 45 to affect the overall light entry possibilities.

In conventional shutter configurations, the a frame system would be cut and constructed, followed by the formation of a shutter door which is then cut on right and left sides, top and bottom to fit within the internal space remaining in the constructed frame. The adjustment of the shutter door would otherwise involve, and using the shutter door system 29 for illustration only, the cutting of the outer edges of the vertical panels 31 & 33, and the top of the upper connector panel 41 and the bottom of the lower connector panel 43.

Cutting is usually accomplished to leave a shutter door both vertically and horizontally centered. As a result, a custom installer, in the case of a conventional shutter door, has four opportunities to over cut a shutter door. An over cut will at best leave the door un-centered and at worse leave a light gap or open space. Further, because the support elements, namely panels 31, 33, 41 and 43 may typically be of glued, pinned and threaded member construction, cutting operations which put even a moment of high stress on these members which are typically structurally designed only to uphold their own weight can result in permanent damage. Any movement can also damage any conventional louvers present.

As will be seen, the quantitative shutter construction system 11 is constructed from a series of components of selected quantitative size which are pre formed within exact tolleranges to enable them to fit and work perfectly together. The quantitative shutter construction enable a fit of the resulting structure over any window opening with a resulting difference from a precise custom fit of no more than one quantum of length (which may preferably be quarter of an inch in the English system, and a centimeter in a metric system) in either of the vertical or horizontal directions to yield an average deviation statistically of about half of the quantum of length. In the case of one quarter of an inch for example, the average difference from a perfect fit is expected to be about one eighth of an inch in any direction.

Referring to FIG. 2, an exploded view of the components of the quantitative shutter construction system 11 of FIG. 1 will illustrate orientational details which are important for further detailed discussion of the later drawings. At the left, the decorative molding 21 is seen to be cut from a single repeating pattern length of material with the corner cuts creating somewhat of an impression of an angled symbol. The decorative molding 21 is a strip of material which can be of a sufficient width to fit within a slot 51 seen as existing between inside edge surface 23 and outside edge surface 25 of the frame members 13, 15, 17, and 19. The dimensioning of the pattern on the decorative molding 21 should be that a length difference in the molding 21 by an even quarter of an inch would produce an even pattern. Pre-manufactured lengths of a quarter inch difference in size is contemplated.

A three dimensional look at the frame members 13, 15, 17, and 19 illustrates an optional flange 55 which is generally even with a rear surface 57. The flange 55 has a front surface 59 which lies adjacent a side inwardly directed surface 61 terminating at the inside edge surface 23. The flange 55 is generally utilized as a stop for the inward motion of the shutter door system 29, and any stop structure may be used instead. Flange 55 does not contribute to a pre-selectable vertical dimension nor a pre-selectable horizontal dimension as part of an opening to accommodate the shutter door system 29 for purposes of the description herein, especially as the flange 55 forms a stop and a stop could be supplied by any structure. The terms pre-selectable vertical dimension and pre-selectable horizontal dimension relate to the dimensions provided within which the shutter door system 29 fits.

As can also be seen, the frame members 13, 15, 17, and 19 may be fitted with chamfered bores 65 which are sized to accept threaded members through the frame members 13, 15, 17, and 19 to enable the heads of threaded members to be completely inset beneath the surface of the slot 51.

In conventional shutter configurations, the a frame system would be cut and constructed, followed by the formation of a shutter door which is then cut on right and left sides, top and bottom to fit within the internal space remaining in the constructed frame. The adjustment of the shutter door would otherwise involve, and using the shutter door system 29 for illustration only, the cutting of the outer edges of the vertical panels 31 & 33, and the top of the upper connector panel 41 and the bottom of the lower connector panel 43.

Cutting is usually accomplished to leave a shutter door both vertically and horizontally centered. As a result, a custom installer has four opportunities to over cut a shutter door. An over cut will at best leave the door un-centered and at worse leave a light gap or open space. Further, because the support elements, namely panels 31, 33, 41 and 43 are typically of glued construction, cutting operations can put stress on these members which are typically structurally designed only to uphold their own weight. Any movement can also damage any louvers present.

As will be seen, the quantitative shutter construction system 11 is constructed from a series of components of selected quantitative size to enable a fit over any window opening with a resulting difference from a precise custom fit of no more than one quarter of an inch in either of the vertical or horizontal directions to yield an average deviation of one eighth of an inch.

The frame members 13, 15, 17, and 19 may be used to attach to the outside periphery of a window opening such that the rear surface 57 abuts a flat wall. In this configuration, there is significant latitude for the frame members 13, 15, 17, and 19 to fit such that the window opening corner (not shown) could extend inside of the extent of a line of the chamfered bores 63 a point beyond the innermost extent of the flange 55. Providing a significant overlap will assist the installer where the underlying better wall studs for attachment are located farther back from the opening. The frame members 13, 15, 17, and 19 could be mounted just inside a window opening with chamfered openings extending from the side inwardly directed surface 61 to a lateral outside surface 67 of the frame members 13, 15, 17, and 19. Further stability will be seen to be obtainable by deviating from an even rear surface 57 to enable lateral abutment with both the face and inside surfaces of a window opening.

Also seen are a series of pins 69 extending from the opposite ends of the louvers 45 and which interfit into a series of evenly drilled blind bores 70 seen on the second vertical panel 33 and which exist but cannot be seen on the first vertical panel 31.

The shutter door system 29 shown consists of a single shutter door, and additional doors can be had by duplication of the components of the shutter door system 29. The pivoting connections are not seen for clarity, but details for orientational identity are seen on the first and second vertical panels 31 and 33 as a decorative groove 71 on both sides. The upper and lower connector panels 41 and 43 can be identical and have a groove 73 which extends about half of the depth of thickness of the material along one surface.

Again, the upper and lower connector panels 41 and 43 may not be identical, as where a vertical size difference of only a vertically prime quantum distance amount is had so as to dictate a slightly different vertical size of upper and lower connector panels 41 and 43, the appearance remains generally visually centered or at least visually vertically offset by an unremarkable amount. Given that for a given set of shutters 45 and control bar 47, which require a given width and height of clearance between the upper and lower connector panels 41 and 43, the height of the upper and lower connector panels 41 and 43 are all which need to be set to control the vertical height of the middle section of the shutter door system 29.

Likewise, the first and second vertical panels 31 and 33 can be available in a series of exact sizes which equal the prime quantum multiple of the height sizes for the combined height of the given set of shutters 45 with control bar 47, and upper and lower connector panels 41 and 43. Where the first and second vertical panels 31 and 33 are pre-drilled to support louvers 45 the pre-drilled pattern will support the offset. As a result, pre-drilled sets of first and second vertical panels 31 and 33 will be available in different sized lengths and where every other size will likely be drilled to support an offset fitting of upper and lower connector panels 41 and 43. As a result, the height of the shutter door system 29 can be set by simply selecting the component parts which are available in vertical sizes which differ by a prime quantum distance magnitude. The components to be selected include the upper and lower connector panels 41 and 43, and the first and second vertical panels 31 and 33.

For a given number and type of given set of shutters 45 with control bar 47, the width of the upper and lower connector panels 41 and 43 are set. Thus for horizontal size selection, a horizontal prime quantum magnitude will be chosen which need not be the same as the vertical prime quantum magnitude. In other words, for a given system 11, the horizontal prime quantum magnitude can be different from the vertical prime quantum magnitude. For horizontal size selection, the widths of the first and second vertical panels 31 and 33 will be relied upon predominantly. However, customers would be given options based upon different width sets of louvers 45. For quantitative shutter construction system 11 having multiple shutter door system 29, any width size requirement can be spread over an applicable number of shutter door systems 29.

Where two shutter door system 29 are present, the possibilities to maintain symmetry include choices to make two of the first vertical panels 31 of one dimension and the other of the two of the second vertical panels 33 of a slightly different dimension and still not lose the horizontal centered nature of the shutter doors. Likewise, four shutters enable any horizontal size differences (which are prime quantitative distance differences) to be spread among eight members, four each of the first and second vertical panels 31 and 33. In the alternative, the shutter door systems 29 could be selected to be different in width, and this may especially be effective for a four shutter system. In any event, the possibility to maintain horizontal symmetry is high.

In the worse case, the center second vertical panel 33 could be made to be one prime quantum measure greater or less than an opposing second vertical panel 33 in order to form an exact fit. However, by “exact fit” it is meant that the tolerances intended for an even quantum magnitude fit should also be accounted for. Tolerance can be planned into the system by providing actual dimensions which are expected to statistically work well together for the best fit.

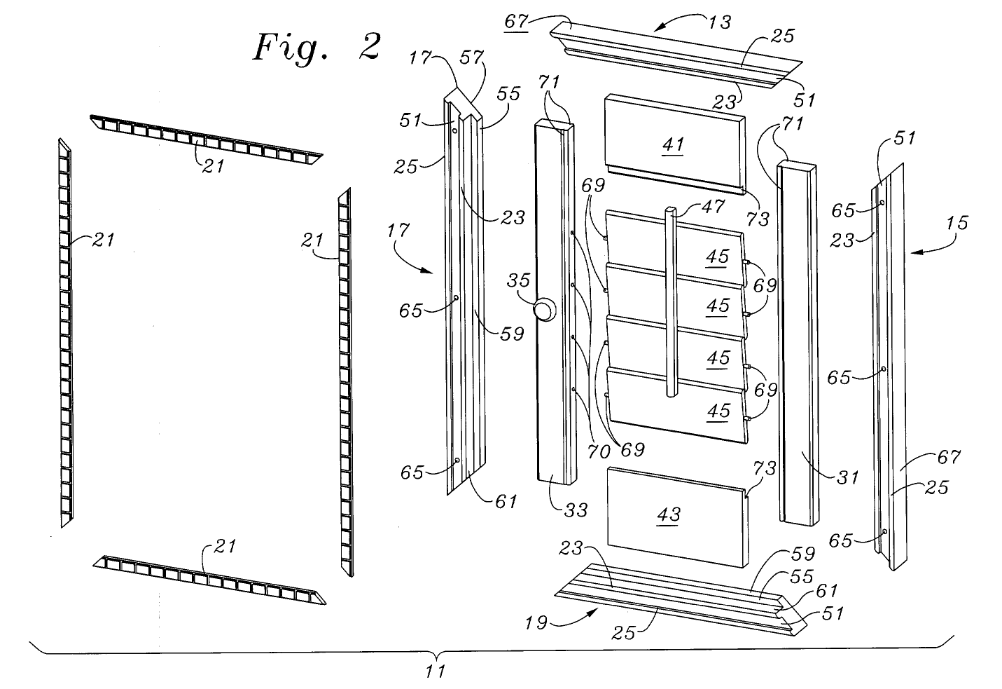

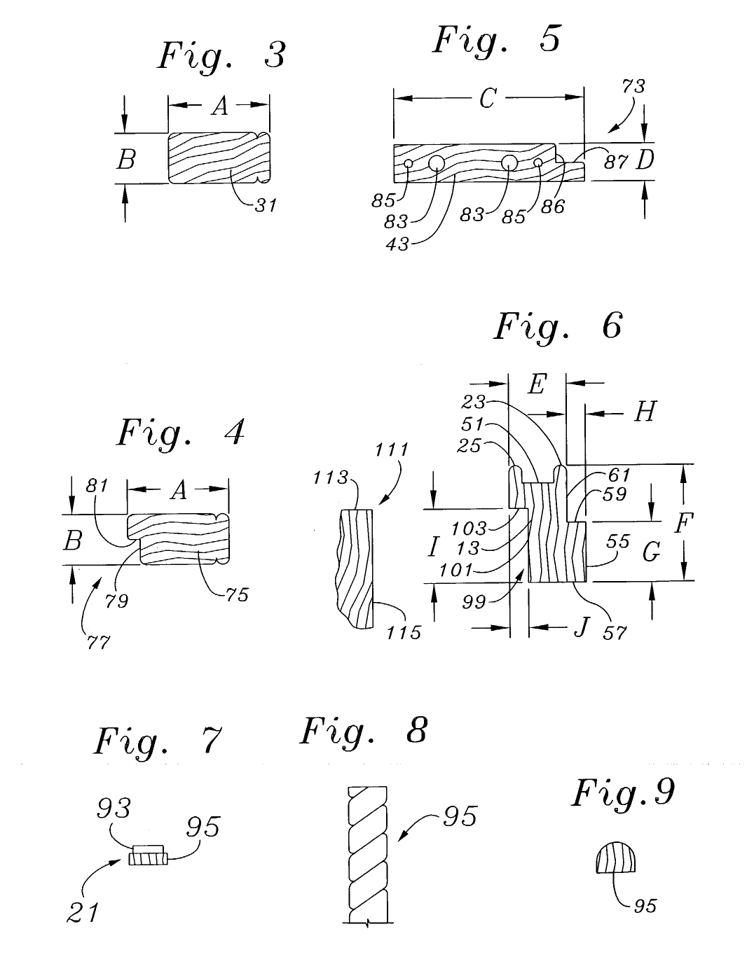

Next, dimensioning of various components will be seen. Referring to FIG. 3, an end view of first vertical panel 31 having a width “A” and a thickness “B”. The “A” dimension for a system 11 based upon English units with a prime quantum difference of a quarter of an inch would have values of 3.0, 2.75, 2.50, 2.25, 2.00, 1.75, 1.50, 1.25, 1.0, 0.75 inches with preferred dimensions centering on 2.00 inches where possible. The “B” dimension is expected to be about 1.0625 inches (1 and 1/16), but can be narrower or thicker. The “B” dimension is accounted for in the outer frame system 27, but does not otherwise come into play as an absolute value in horizontal and vertical sizing.

Referring to FIG. 4, an end view of a second vertical panel 75 is also shown having a width “A” and a thickness “B” of the same potential dimensions as set forth above. Unlike second vertical panel 33, a notch 77 is shown having a depth surface 79 which, as a part of the “B” dimension is about 9/16 of an inch leaving a projection width of about one half inch. The notch 77 has a depth surface 81 which, as a part of the “A” dimension which causes the projection length to be about ¼ of an inch. The material removed by the notch 77 can be used to accommodate differing types of hinges between adjacent shutter door systems 29 or the meeting point at the center between a pair of shutter door systems 29.

Referring to FIG. 5, a side view of the lower connector panel 43, which is dimensionally exactly the same as the upper connector panel 41, illustrates the dimensions. An overall length “C” is also seen to have the dimensions which may differ by the prime quantum dimension. For English unit, the dimensions which have been found to work well include values of 6.0, 5.75, 5.50, 5.25, 5.00, 4.75, 4.50, 4.25, 4.0, 3.75, 3.50, 3.25, 3.00, 2.75, 2.50, 2.25, 2.0, 1.75, 1.50, 1.25, and 1.00 inches with preferred dimensions centering on about 4.5 inches where possible. However, even the preferred dimension gives way to a customer's desire to have a high area of occupancy by a series of louvers 45. Where a wider and more open louver area is desired, the dimension “C” can be reduced, but due consideration must be given to the structural integrity. Wood, plastic and metal and more can be used as construction materials. Enough plain material or plain material supplemented by structural assistance members may be utilized.

The thickness of the lower connector panel 43 is seen to be a dimension “D” having a value of about ¾ of an inch. The lower connector panel 43 notch 73 has depth surface 86 which, as a part of the “D” dimension has a dimension which is about 13/32 of an inch leaving a projection width of about 11/32 of an inch. The notch 73 has a depth surface 87 which, as a part of the “C” dimension causes the projection length to be about 9/16 of an inch. The material removed by the notch 73 is used to accommodate the ending edges of the terminal ones of the louvers 45 which are arranged in a series. The upper connector panel 41 is arranged somewhat opposite the lower connector panel 43 with regard to the notch 73 to accommodate the ending sweep of the outside of the louvers 45.

A series of pre-drilled bores 83 and smaller pilot bore 85 may be provided to facilitate connection of the upper and lower connector panels 41 and 43 to the right side frame member 15 and left side frame member 17. Other methods of attachment are acceptable, including tongue and groove fit, or threaded members inserted from the outer sides of the side frame member 15 and left side frame member 17, especially by chamfered bores.

Referring to FIG. 6 an end view of the frame members 13, 15, 17, and 19 is seen as a frame member 13. The dimensions of the frame member 13 is seen as including an overall width dimension “E” of about one and a half inches and which extends from lateral outside surface 67 to side inwardly directed surface 61. The frame member 13 has a height from the rear surface 57 to the outside edge surface 25 (generally even with surface 23) having a dimension “F” which may be from about four inches to about one inch, but nominally having values of about 2 and 15/16 inches, 1 and 13/16 inches, and 1 and ⅛ inches.

The width (depth taken with respect to the frame perspective) of the optional flange 55 may have values “G” of about 1 and 3/16 to 11/16, to zero where it is eliminated. The front surface 59, of the optional flange 59, has a dimension “H” which may preferably have a value of from about one half inch to zero inches for the case where the flange is eliminated. Dimension “H” is preferably about ⅜ of an inch.

The depth of the slot 51 with respect to the inside and outside edge surfaces 23 and 25 is preferably about 11/32 of an inch and the width of the slot 51 for a relatively small installation is preferably about ⅝ of an inch and set to accommodate a decorative molding 21 which is nominally ⅝ of an inch wide. For larger installations the slot 51, and decorative molding 21 may be much larger, especially wider, on the order of one to two inches wide and preferably about 1 and ⅜ inches wide.

As a further variation, a notch 99 may be formed to enable a much larger portion of the deeper extent of the frame member 13 to fit deeper inside a window or door opening while providing an overlap on the window opening. The notch 99 has a depth dimension “I” on surface 101 which may be from about one half inch to about two and a half inches and which may have a preferred value of about 1 and ⅛ inches. The notch 99 has a width dimension “J” on surface 103, which may be from about one half inch to about four inches and which may have a preferred value of about 1 and ½ inches.

The upper frame member 13 is shown adjacent a window opening 111. The window opening 111 having an outer surface 113 and an inside surface 115 is seen in approximately the position it would fit into notch 99 were notch present. Where no notch 99 is present, the rear surface 57 may fit directly onto the outer surface 113 or laterally onto the inside surface 115.

Referring to FIG. 7, an end view of the decorative molding 21 shows a continuous base member 91 which is nominally ⅝ of an inch wide. The base member 91 is shown as being topped with a series of decorative tile shaped projections 93 for producing a decorative pattern. In the alternative, the decorative molding 21 can be provided as a continuous length of material with any sort of pattern or even plain. The tile shaped projections 93 can be cut from a solid piece of decorative molding 21.

Referring to FIG. 8, a decorative molding 95 shows a rope pattern where the rope twists are at approximately 45° to assist in making the 45° miter cuts at the end of the slot 51 to make a matching pattern. Referring to FIG. 9 an end view shows that the decorative molding 95 illustrates a single piece construction with the pattern formed by cutting or pressing or molding. Further, the system 11 enables the constructor to also provide to user's a series of sets of different decorative moldings 21 and 95. Users may be then able to easily change different decorative moldings 21 and 95. Because of the quantum lengths used in the frame system 27, an exact set of lengths of decorative moldings 21 and 95 will be available.

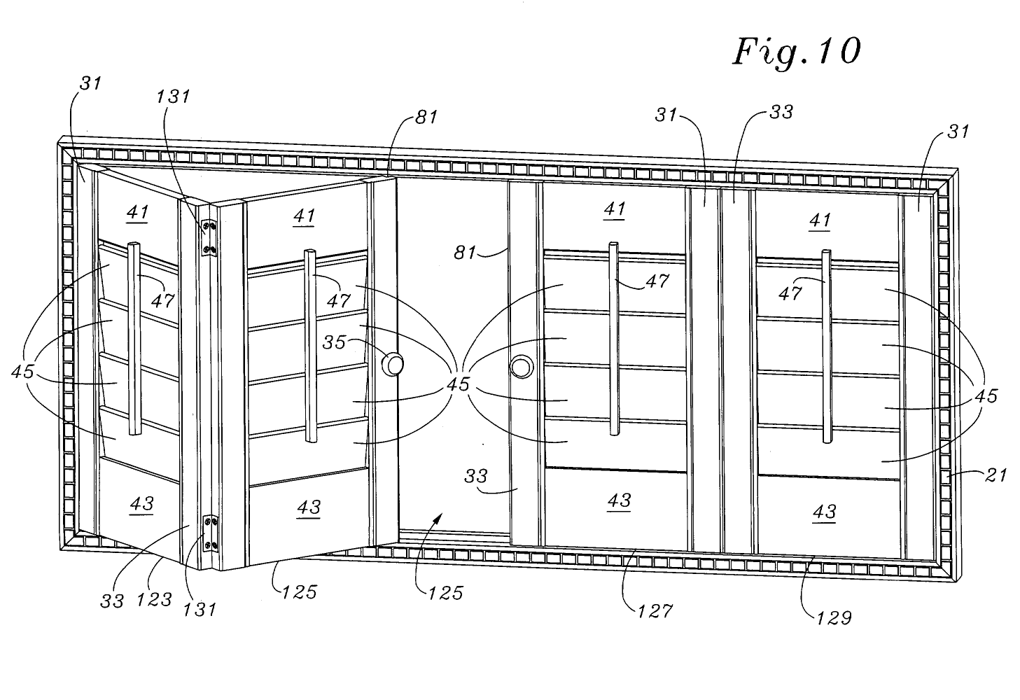

Referring to FIG. 10 a shutter set 121 having four shutter door systems 29 seen as shutter door systems 123, 125, 127 and 129 mounted such that shutter door systems 123 and 129 are pivotally mounted to the frame system 27 while system 123 is mounted to system 125 (using hinges 131) and system 127 is pivotally mounted to system 129. Hinges 131 which pivotally join shutter door systems systems 123 and 129 to the frame system 27 are hidden from the perspective of FIG. 10. A shutter set similar to shutter set 121 could be constructed for 1, 2, 3, 4, 5 or more shutter door systems 29. The shutter systems 29 could be multiply hinged together or a single frame system 27 could support a series of shutter systems 29 hingeably affixed along the central frame opening 135 seen in FIG. 10. Further, individual shutter systems 29 could be stacked within the central frame opening to form row series of shutter systems 29 which open over and under each other independently. In the alternative, a series of frame systems 27 can be installed next to each other in a closely adjacent repeating pattern, especially as to cover a large, wide open window opening 111. The use of multiple frame systems 27 will add the additional support stabilization for the internal shutter door systems 29.

In terms of installation, and referring to FIG. 6, a window opening ill may have a width of, for example, 110.125 inches and a height of 48 inches. The frame members 13 and 19 would be chosen so that the width of the surfaces 101 of the notch 99 would be 110.00 inches wide and the surfaces 101 of the frame members 15 and 17 would be chosen so that the height of the surfaces 101 of the notch 99 would be 48.00 inches tall in order to form a frame which fits exactly vertically and is under fitted by additional 0.125 total, typically to be split between right and left sides of the frame system 27. The difference would be made up with shims in order to get a good interference fit. Once threaded members are extended into the chamfered bores 65, any shimming will be locked into place.

Because the frame members 13, 15, 17, and 19 are pre-cut and differ by primary quantum length magnitudes such as ¼ of an inch for the English system, no cutting is necessary. Where the quantity “E” is 2 and ½ inches and the quantity “J” is 1 and ½ inches, and the quantity “H” is ⅜ of an inch clearance yields an internal space bounded by the side inwardly directed surface 61 would be the nominal 110.00 inches minus ⅝ of an inch at each end to yield a width of 108 and ¾ inches.

The same math applied to the vertical dimension would yield a minus ⅝ of an inch at each end to yield a height for the shutter door system 29 of 46 and ¾ inches. This insures that all further internal dimensioning will be some even multiple of the principal quantum difference magnitude, the example being given for English units of ¼ of an inch.

The 108 and ¾ inches inside the frame system 27 can be then divided among three (three are used as an example only) shutter door systems 29 within a single central frame opening 135. The use of three shutter door systems 29 will yield three shutters each 36 and ¼ inches wide (excluding any computations or consideration of space occupied for hinges, etc.), or four shutter door systems 29 which are 27 and 3/16 inches wide. Assuming that the louvers 45 are 18 inches wide, 9 and 3/16 inches are to be spread over the right side frame member 15 and left side frame member 17. Dividing again by two, each member 15 and 17 would be ideally 4 and 19/32 inches each. In terms of units of primary quantum measure of ¼ of an inch, or 8/32 of an inch, the closest selection would be a selection of 4 and 16/32 leaving 3/32 left over. If a dimension “A” of 4 and ½ were chosen, a light gap of 4×3/32 or 12/32 would result.

Recall, however that surface 81 provides for a double overlap of the two center meeting shutter door systems 29 of ¼ inch. Since 12/32 is greater than the quantum difference of 8/32, one of the center second vertical panels 33 would be chosen to be 4 and ¾ inches and the other would be chosen to be 4 and ½ inches. This results in an outside gap of 4/32 or ⅛ of an inch which would be well covered by the overlap of ¼ of an inch by the opposing surfaces 81. The foregoing assumes that when the two second vertical panels 33 meet, one of the surfaces 81 faces in one direction and the other surface 81 faces oppositely and in the other direction. If a larger or smaller number of shutter door systems 29 were selected to fit within a single central frame opening 135, the comput ation would differ by the number of shutter door systems 29 among which the horizontal dimension were spread, but the procedure outlined above would be the same.

If there are other dimensions to be added for example if hinges occupy horizontal space and the like, it can be taken to account. In an equation to determine which parts to select. As can be seen, because of the basic math involved, the above method is especially amenable to being realized on a computer. In the above example, the computer would give the client the choice of number of second vertical panels 33 desired, as well as a different number of second vertical panel 33 where a different width set of louvers 45 were specified. With computer graphics the overall look and operation of the resulting shutter set could be seen by the customer and shown with respect to wall height and other room visual indicia entered. Where a photo of the window is scanned in, the operation of the shutter systems selected could be shown with respect to the windows over which the shutter system is intended to fit.

Similarly to the above, the shutter door system 29 would have a height of 46 and ¾ inches, and assuming that the height of the set of louvers 45 is 36 inches excluding the portion which would fit into the notch 73, of 10 and ¾ inches remain to be divided between upper connector panel 41 and lower connector panel 43. Because the 10 and ¾ inches is not evenly divisible, the upper connector panel 41 will have a height of 5 and ¼ inches while the lower connector panel 43 will have a height of 5 and ½ inches.

As can be seen from the above example, the potential to select different size and number of louver door sets for the internal structures represents the more complicated computations and wider tolerances even though the internal horizontal space available in the frame system 27 will be an even multiple of the primary quantum measure. Because the vertical measure will always be divided among the two connector panels 41 and 43, the vertical tolerance will generally always be more closely controllable automatically.

The system 11 provides for extreme flexibility in modes of sale and manufacture. A user can specify the window opening 111 size and a manufacturer, without custom cutting, can assemble the complete system with shims to either a customer or an installer for one piece installation. Further, the installer can use the computer to order the base components from the manufacturer as a kit for assembler construction, or can order the completed system 11 direct from the manufacturer. Flexibility is had in terms of where, in terms of the vertical distribution chain, the component parts are kept.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A shutter system constructing utilizing components having prime quantum magnitude difference in at least one of a horizontal and a vertical direction comprising:
a frame including an upper and a lower frame member having a first frame width having a first horizontal integer multiple number of quantum magnitude frame width, and a right and a left side frame member having a first vertical integer multiple number of quantum magnitude frame height to create a frame opening having dimensions of a pre-selectable horizontal frame dimension and a pre-selectable vertical frame dimension, said upper and lower frame members and said right and left frame members attached to form said frame opening for accommodating at least one shutter door;
at least one shutter system having first vertical panel spaced apart from a second vertical panel, said first vertical panel having a first vertical length and a first horizontal width, said second vertical panel having said first vertical length and a second horizontal width, said first and said second vertical panels connected to each other by an upper connector panel spaced apart from a lower connector panel, said upper connector panel having a second vertical length and a third horizontal width, said lower connector panel having a third vertical length and said third horizontal width;
a louver set having at least one louver pivotally supported between said first and said second vertical panel and closing adjacent said upper connector paneland said lower connector panel and having, in a closed position, a fourth vertical length and said third horizontal width, and wherein a first sum of said second, third and fourth vertical lengths equal said first vertical length and share a common quantum multiple with said pre-selectable vertical frame dimension, and wherein a second sum of said first, second and third horizontal widths of each at least one shutter system within said frame opening shares a common quantum multiples with said pre-selecteable horizontal frame dimension.

2. The shutter system recited in claim 1 wherein said frame members, including said upper and a lower frame member and said right and a left side frame member define a plurality of threaded member accommodating bores in a slot between an inside edge surface and an outside edge surface and further comprising decorative molding carried within said slot to cover said plurality of threaded member accommodating bores.

3. The window frame molding system recited in claim 2 wherein said at least one shutter system is at least two shutter systems and wherein each shutter system is pivotally mounted to said frame.

4. The window frame molding system recited in claim 2 wherein said at least one shutter system is at least four shutter systems and wherein a first two of said at least four shutter systems are pivotally mounted to said frame and wherein a second two of said at least four shutter systems different from said first two of said at least four shutter systems are pivotally mounted to said first two of said at least four shutter systems.

5. The window frame molding system recited in claim 1 wherein said first horizontal integer multiple number of quantum magnitude frame width includes a non-quantum magnitude distance, and wherein said first vertical integer multiple number of quantum magnitude frame height also includes a single non-quantum magnitude distance portion.

6. The window frame molding system recited in claim 1 wherein said quantum magnitude frame width is equal to said quantum magnitude frame height and said pre-selectable horizontal frame dimension subtracted from said pre-selectable vertical frame dimension is a difference having an integer multiple of said quantum magnitude frame width.

7. The window frame molding system recited in claim 1 wherein a first difference between said first vertical length and at least one of said second vertical length and said third vertical length shares a quantum multiple of a second difference between said second vertical length and said third vertical length.

8. The window frame molding system recited in claim 1 wherein said pre-selectable vertical frame dimension magnitude has a common quantum multiple with respect to at least one of said second vertical length and said third vertical length and a sum of said second vertical length and said third vertical length.

9. The window frame molding system recited in claim 1 wherein a first difference between said first horizontal width and at least one of said second horizontal width and said third horizontal width shares a quantum multiple of a second difference between said second horizontal width and said third horizontal width.

10. A process of constructing a shutter system comprising the steps of:
measuring a window opening to obtain an actual horizontal opening dimension and an actual vertical opening dimension;
specifying a pre-selectable horizontal frame dimension at a next lesser one of a possible prime quantum horizontal dimension to minimize a difference between said actual horizontal opening dimension and said pre-selectable horizontal frame dimension to an amount less than said prime quantum horizontal dimension;
specifying a pre-selectable vertical frame dimension at a next lesser one of a possible prime quantum vertical dimension to minimize a difference between said actual vertical opening dimension and said pre-selectable vertical frame dimension to an amount less than said prime quantum vertical dimension;
Specifying a frame by selecting an upper and a lower frame member having a first length which is a first horizontal integer multiple number of quantum magnitude difference, and a right and a left side frame member having a first vertical integer multiple number of quantum magnitude difference to create a frame opening having a pre-selected horizontal and a pre-selected vertical dimension;
attaching said upper and lower frame members and said right and left frame members to form said frame opening for accommodating at least one shutter door;
constructing at least one shutter system having first vertical panel spaced apart from a second vertical panel, said first and said second vertical panels each having a first vertical length and a first horizontal width, said first and said second vertical panels connected to each other by an upper connector panel spaced apart from a lower connector panel, said upper connector panel having a second vertical length and a second horizontal width, said lower connector panel having a third vertical length and said second horizontal width and a louver set having at least one louver pivotally supported between said first and said second vertical panel and closing adjacent said upper connector panel and said lower connector panel and having, in a closed position, a fourth vertical length and a fourth horizontal width, and such that said sum of said second, third and fourth vertical lengths equal said first vertical length and said pre-selected vertical dimension, and such that a sum of said first and second horizontal widths times the number of said at least one shutter system within said frame opening is equal to said pre-selecteable horizontal dimension.
